(19) United States
(12) Patent Application Publication
(10) Pub. No.: US 2015/0151630 A1
(43) Pub. Date: Jun. 4, 2015

(54) EXPLOSION AND BALLISTIC RESISTANT FUEL TANKS UTILIZING MOLDED POLYMER INNERLINERS, COMPOSITE FABRICS AND SELF-SEALING MATERIALS

(71) Applicant: Meggitt (Rockmart) Inc., Rockmart, GA (US)

(72) Inventor: Paul M. Bethea, Cedartown, GA (US)

(73) Assignee: Meggitt (Rockmart) Inc., Rockmart, GA (US)

(21) Appl. No.: 14/095,392

(22) Filed: Dec. 3, 2013

(51) Int. Cl. B60K 15/03

(52) U.S. Cl. CPC B60K 15/03177; B60K 2015/03493

(57) ABSTRACT

A fuel tank includes a fuel container and a composite layer covering at least a portion of the exterior of the fuel container, the composite layer including a reinforcing fabric surrounded and supported by a matrix material.

### FIELD OF THE INVENTION

The present invention generally relates to fuel tanks. More particularly, this invention relates to fuel tanks including molded polymeric fuel containers employed as innerliners that are coated with composite layers and reinforcement fabrics and self-sealing materials to improve their explosion and ballistic resistance. This invention is also directed to processes for the creation of such fuel tanks.

### BACKGROUND OF THE INVENTION

Fuel tanks for automotive vehicles have progressed from sheet metal fabrications to molded plastics. Literature in the field describes products based on polyamide and polyethylene resin systems using various molding technologies such as rotomolding and blowmolding depending on the size of the desired tank. These tanks have also been utilized in military land vehicles especially those designed for non-combat, low threat areas of military operations or those manufactured utilizing essentially commercial automotive processes.

With the advent and proliferation of improvised explosive devices (IEDs) and similar explosive threats, these fuel tanks have become unacceptably vulnerable even in the low threat areas in which they have been employed. Adding heavy armor or costly active suppression systems to protect the vehicle occupants is somewhat effective but wears out vehicle suspensions and frames, reduces load carrying capacity, changes transport and logistics criteria, consumes limited budgets and, with other similar outcomes, is generally undesirable.

There is a need in the art to reduce the vulnerability of these plastic tanks while retaining their simplicity, and doing so at a moderate cost.

### SUMMARY OF THE INVENTION

A first embodiment of this invention provides a fuel tank comprising a fuel container and a composite layer covering at least a portion of the exterior of said fuel container, said composite layer including a reinforcing fabric surrounded and supported by a matrix material.

A second embodiment of this invention provides a fuel tank as in the first embodiment, wherein said fuel container is a molded fuel container.

A third embodiment of this invention provides a fuel tank as in either the first or second embodiment, wherein said molded fuel container is made from materials selected from the group consisting of fuel resistant thermoplastic materials and fuel resistant thermoset materials and nanomaterials formed therefrom.

A fourth embodiment of this invention provides a fuel tank as in any of the first through third embodiments, wherein said reinforcing fabric is formed from materials selected from the group consisting sheet-like, woven or non-woven fiberglass, aramid fibers, para-aramid fibers, carbon fibers, polyamide fibers, polyethylene fibers, quartz fibers, ceramic fibers, polybenzoxazole (PBO) fibers, boron fibers, basalt fibers, natural fibers, additive manufactured/3D printed textiles, and nanotextiles versions of the aforementioned.

A fifth embodiment of this invention provides a fuel tank as in any of the first through fourth embodiments, wherein the reinforcing fabric has a weight of greater than 340 g/m2.

A sixth embodiment of this invention provides a fuel tank as in any of the first through fifth embodiments, wherein said reinforcing fabric has a thickness of from 30 to 50 thousandths of an inch (mils).

A seventh embodiment of this invention provides a fuel tank as in any of the first through sixth embodiments, wherein said matrix material is selected from the group consisting of formulated rubbers and elastomers having self-sealing properties.

An eighth embodiment of this invention provides a fuel tank as in any of the first through seventh embodiments, wherein said matrix material is urethane elastomer.

A ninth embodiment of this invention provides a fuel tank as in any of the first through eighth embodiments, wherein said matrix material has a thickness of less than 20 mils.

A tenth embodiment of this invention provides a fuel tank as in any of the first through ninth embodiments, further comprising a self sealing layer.

An eleventh embodiment of this invention provides a fuel tank as in any of the first through third embodiments, wherein said self-sealing layer includes a fuel-activated component that swells when in contact with fuel.

A twelfth embodiment of this invention provides a fuel tank as in any of the first through eleventh embodiments, wherein said fuel-activated component is selected from the group consisting of natural rubber and compressed polyurethane foam

A thirteenth embodiment of this invention provides a fuel tank as in any of the first through twelfth embodiments, wherein said self-sealing layer includes a fabric layer for reinforcement.

A fourteenth embodiment of this invention provides a fuel tank as in any of the first through thirteenth embodiments, comprising first and second self-sealing layers, wherein said first self-sealing layer includes a first fabric layer reinforcing a fuel-activated component, said first fabric layer being a woven fabric, and said second self-sealing layer includes a second fabric layer reinforcing a fuel-activated component, said second fabric layer being a woven fabric, wherein the woven pattern of said second fabric layer is positioned at an angle to the woven pattern of said first fabric layer.

A fifteenth embodiment of this invention provides a fuel tank as in any of the first through fourteenth embodiments, further comprising a polymeric outer layer.

### BRIEF DESCRIPTION OF THE DRAWINGS

FIG. 1 is a perspective view of a first embodiment of a fuel tank in accordance with this invention, with a portion thereof shown in cross section to show layers of the materials forming the fuel tank;

FIG. 2 is cross-sectional view of the layers of a second embodiment of a fuel tank in accordance with this invention;

FIG. 3 is cross-sectional view of the layers of a third embodiment of a fuel tank in accordance with this invention; and

FIG. 4 is cross-sectional view of the layers of a fourth embodiment of a fuel tank in accordance with this invention.

### DETAILED DESCRIPTION OF ILLUSTRATIVE EMBODIMENTS

A fuel tank in accordance with this invention is produced by coating a fuel container with various layers of protection. In this invention, the fuel container serves as an innerliner that is coated with a plurality of layers of various materials in order to provide a completed fuel tank having improved explosion and ballistic resistance. The layers include at least one composite layer to provide strength and protection from explosive shrapnel and ballistic material, at least on self-sealing layer to reduce the size of or even plug a hole punctured through the layers and the fuel container, and a polymeric outer layer. Notably, the self-sealing layer(s) will be sandwiched either between the fuel tank and a composite layer or between two composite layers.

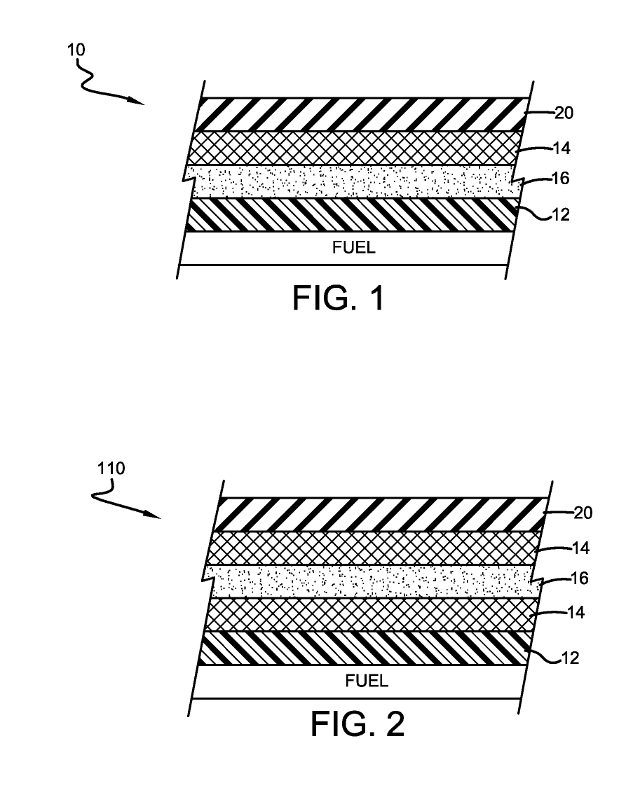

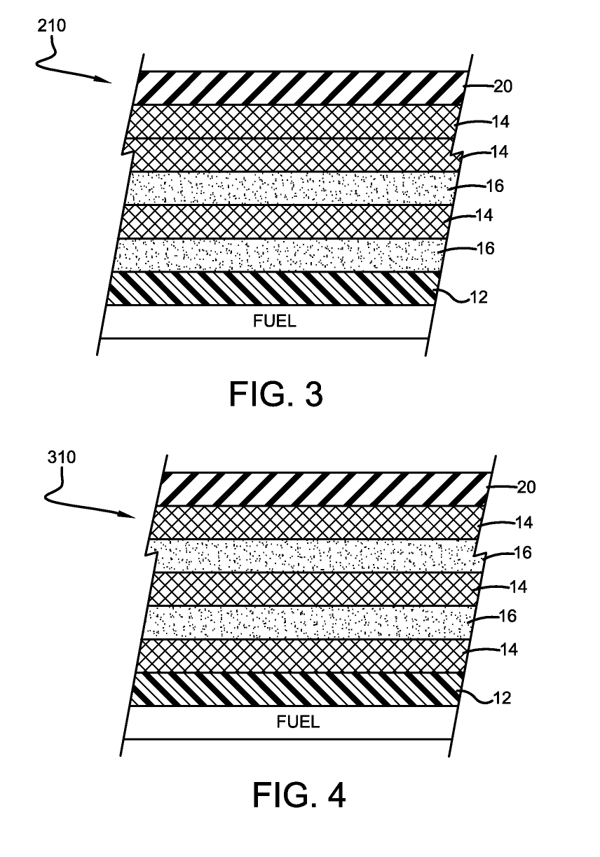

Thus, referring now to FIG. 1, a first embodiment of this invention provides a fuel tank 10 that includes a fuel container 12 that is covered with a self-sealing layer 16, which is in turn covered with at least one composite layer 14, with is in turn covered with a polymeric outer layer 20. By use of the term “at least one composite layer 14” it should be clear that additional strength and ballistic protection can be imparted by the use of additional composite layers between the composite layer 14 and the polymeric outer layer 20. In another embodiment, shown in FIG. 2, a fuel tank 110 is provided wherein a fuel container 12 is first coated with at least one composite layer 14, which is covered with a self-sealing layer 16, which is then covered with at least one composite layer 14, followed by a polymeric outer layer 20. In yet other embodiments, multiple self-sealing layers 16 are employed, as seen in FIGS. 3 and 4. In FIG. 3, a fuel tank 210 includes a fuel container 12 that is covered with a self-sealing layer 16, which is in turn covered with a composite layer 14, which is in turn covered with a second self-sealing layer 16, covered by with at least one composite layer 14 (two such layers being shown in FIG. 3), which is in turn covered with a polymeric outer layer 20. In FIG. 4, a fuel tank 310 includes a fuel container 12 that is first coated with at least one composite layer 14, which is covered with a self-sealing layer 16, which is then covered with at least one composite layer 14, followed by a second self-sealing layer 16, further covered by at least one composite layer 14, finally covered with a polymeric outer layer 20.

Thus, the included Figures show examples of self-sealing layer placement for 1, 2 or 3 ply applications of the invention, the “ply” being the composite layer. The design choices increase as the number of coated fabric plys increase. Notably, although this invention is not to be limited to any particular number of layers/plys, it is believed that three layers of coated fabric are a practical limit when a cost/benefit outcome is considered. Thus, while the figures are intended to be illustrative of the invention, they do not reflect all embodiments in accordance with the concepts taught herein, and are to be understood as examples only. The number of layers employed will be related to the required performance for a given application. It is expected that two or three layers will be typical to provide the necessary reinforcement and self-sealing properties to protect against explosion and ballistic projectiles.

The fuel container 12 can be created through known processes or simply obtained as an already existing fuel container. It may have a specific shape, including bosses and contours and channels suitable for allowing the container to fit into confined spaces within a land vehicle. Suitable fuel containers 12 will be molded containers made from polyamide, polyethylene or other fuel resistant polymeric materials.

Suitable fuel containers 12 will be molded polymeric containers able to safely retain fuel. This particular invention is directed to fuel tanks for land vehicles, and will find particular application in military land vehicles. Suitable fuel containers 12 will be made from fuel resistant thermoplastic materials and fuel resistant thermoset materials and nanomaterials formed therefrom that are formulated for molding processes that produce hollow, thin wall containers. This includes but is not limited to rotational molding, blow molding, injection molding, vacuum forming, or 3D printed/additive manufacture that might be followed by secondary assembly operations. The invention is not limited or dependent upon the choice of fuel container 12 with respect to polymer chemistry, method of fabrication, shape, size, wall thickness or other adaptable feature. Examples of materials available to be used include nylons of various formulations and polyethylenes formulated for different processing methods.

Generally a suitable material for the fuel container 12 should have thermal stability and long term fuel resistance in the range of world wide environmental conditions of 160° F. to −40° F. In other embodiments, the fuel container will have a minimum melting point of 250° F.

Particular fuel containers for use in this invention include fuel tanks employed in military vehicles, law enforcement, private security, governmental, border patrol, maritime enforcement, homeland security and anywhere that safety and security are concerns. The fuel container may also find application for the vehicles of private individuals.

At least one composite layer is applied to the exterior of the container 12. The exterior of the container 12 is first cleaned and primed to accept and adhere to the composite layer 14. Typically this will mean that the exterior of the container 12 is primed to appropriately adhere to a matrix material employed in the composite layer 14.

Suitable cleaners will be chosen based on the material of the container 12 and the type of composite layer 14 to be applied thereto. Typical cleaners may be selected from solvent degreasers and detergents. The exterior surface of the container 12 is typically cleaned because a clean surface permits better adherence of the applied composite layer 14. The cleaner is typically wiped over the surface to remove any dirt, dust or other debris and/or residual release compounds remaining from the molding.

The surface may be primed by the application of a primer and/or tie cement or through the use of chemical or plasma etching. The surface of the container 12 is primed to increase the interaction between its exterior surface and the composite layer 14. The surface may be primed by mild abrasion/sanding, solvent cleaning, chemical etching, plasma, corona discharge, and other method to prepare the surface reactivity for bonding. In some embodiments, a primer layer may be employed. The primer layer is typically applied as a very thin layer, and suitable primers are those with affinity to the molded fuel container 12. They may include adhesion promoters such as water-borne systems, solvent-borne systems, power coating, and other similar methods to bond to a variety of substrates including anodized aluminum, alodined aluminum, stainless steel, titanium alloy, carbon/epoxy composite, carbon/bismaleimide composite, epoxy coatings, urethane coatings, polysulfide sealants, polythioether sealants, and polyurethane sealants plus carbon nanotube or graphene enhanced versions of the above listed. In some embodiment, the primer is a polyurethane primer. A primer layer 13 is shown in FIG. 2.

The composite layer 14 consists of a reinforcement fabric 22 and a matrix material 24, as generally represented in FIG. 3. The matrix material 24 surrounds and supports the reinforcement fabric to provide an end composite where the reinforcement fabric and the matrix material remain separate and distinct on a macroscopic level. Together, the reinforcement fabric and the matrix material produce a composite having properties different from the individual constituent materials. Although other composite layers exist, this invention is more particularly directed to the use of composite layers that employ sheet-like reinforcement fabrics.

The reinforcement fabric 22 of the composite layer may be selected from sheet-like, woven or non-woven fiberglass, aramid or para-aramid fibers (e.g., Kevlar™) carbon fibers, polyamide (nylon) fibers, polyethylene fibers, quartz fibers, ceramic fibers, polybenzoxazole (PBO) fibers, boron fibers, basalt fibers, natural fibers (such as hemp, jute, and flax), additive manufactured/3D printed textiles, and nanotextiles versions of the aforementioned. When multiple layers of the composite layer 14 are employed, each of the multiple layers of reinforcement fabric 22 may be the same or different. Each may be woven or non-woven, and woven materials might be provided in any particular type of weave, such as plain, satin, braded, stitched, etc, without limitation.

In some embodiments, the reinforcement fabric has a weight of greater than 340 g/m², in other embodiments, greater than 406.8 g/m², in other embodiments, greater than 508.5 g/m², and, in other embodiments, greater than 678 g/m². In other embodiments, the reinforcement fabric has a weight of less than 813.7 g/m², in other embodiments, less than 1020 g/m², in other embodiments, less than 847.5 g/m² and in other embodiments, less than 680 g/m². Particularly useful and preferred reinforcement fabrics for this invention include plain woven polyamides (e.g., nylon) and polyesters having a weight of from 406.8 to 1017 g/m², and even more preferably having a weight of about 813.6 g/m².

Depending upon the weight of the fabric, the preferred fabric may vary in thickness. In some embodiments, the fabric has a thickness of greater than 25 mils (mils=one thousandth of an inch) (635 microns), in other embodiments, greater than 30 mils (762 microns), in other embodiments, greater than 35 mils (889 microns), and, in other embodiments, greater than 40 mils (1016 microns). In some embodiments, the fabric has a thickness of less than 55 mils (1397 microns), in other embodiments, less than 50 mils (1270 microns), in other embodiments, greater than 45 mils (1143 microns), and, in other embodiments, less than 40 mils. Particularly useful and preferred reinforcement fabrics for this invention include plain woven polyamides (e.g., nylon) and polyesters within the range of 40 mils with about 30 to 50 mils being most preferred.

The matrix material 24 of the composite layer 14 may be selected from formulated rubbers and elastomeric materials. In some embodiments, the matrix material 24 of the composite layer 14 can also be chosen to expand when exposed to aircraft fuels as with the self-sealing layers disclosed below. In other embodiments, the matrix material 24 may be selected from natural and synthetic materials like viscoelastic sealant materials such as fluorocarbon, neoprene, nitrile butadiene, styrene butadiene, silicone, fluorosilicone and urethane elastomer. As with the reinforcement fabric 22, when multiple layers of composite layer 14 are employed, each layer of matrix material 24 may be the same or different, and will be chosen for desired properties. The layers are chosen and arranged to provide additional integrity to the tank during a blast or puncture and to assist the sealing layer in closing that tear or puncture.

In some embodiments, the matrix material is a polyurethane elastomer. The elastomer is chosen so as to contain an amount of solids in solution within the range of 20-70% solids. For example, the set time polyurethane elastomer at about 35 to 45% solids is approximately one hour and therefore the set time available between applications of the various plies is sufficient for quality control purposes but is short enough to facilitate a production line type manufacturing process. The elastomer is applied at a preferred rate within the range of 0.38 to 1.89 liters/min dependent upon operator control and to a preferred thickness within the range of about 4 to 20 mils and, more preferably, to about 5 to 8 mils. Based upon this nominal thickness, the elastomer coat should have a weight of about 122 g/m² or less.

Matrix materials should generally have good resistance to fuel, solvents and common cleaning materials. In addition, the properties should permit compliance to the pertinent military and FAA requirements for aviation fuel cells including but not limited to MIL-DTL-27422, MIL-DTL-5578, MIL-T-6396 and TS0-C80.

The layers of composite layer 14 may be applied either with the reinforcement fabric 22 and matrix material 24 applied in different steps or with the reinforcement fabric 22 and matrix material 24 already formed into a composite or “coated fabric.” In the first method, to apply a first layer of the composite layer 14, a sheet of the reinforcement fabric 22 is applied to the exterior of the container 12 and smoothed into place so as to follow the contours of the container 12. The reinforcement fabric 22 is cut or slit in any areas of severe contour. For containers 12 having complicated structure, the fabric 22 may be applied in pieces and patches, as necessary to reach and intimately cover all desired exterior surfaces. Next, the reinforcement fabric 22 is spray-coated or brush coated with a cover ply of matrix material 24—which may also be the previously disclosed polyurethane elastomer—at a preferred rate of about 0.38 to 1.89 liters/min and to a preferred thickness within the range of about 4 to 20 mils and, more preferably, to about 5 to 8 mils. The matrix material 24 will surround and impregnate the fabric 22, ultimately forming the composite layer 14, as described above. In particular embodiments, the matrix material 24 coated onto the reinforcement fabric 22 will be a green, uncured rubber, the green rubber being workable so as to be applied as described. It will later be cured along with the other components of the tank 10.

In the second method, the composite layer 14 is preformed as a reinforcement fabric 22 coated and impregnated with matrix material 24, and it is this composite layer 14 that is applied to the exterior of the container 12 and smoothed into place so as to follow the contours of the container 12. Slits and pieces and patches may be employed as already described with respect to the prior process. In this method, the composite layer 14 may be coated with a green, uncured rubber, the green rubber being workable so that it may be applied to the container 12. It will later be cured along with the other components of the tank 10.

The composite layer 14 is applied in patterns that, when appropriate to the selected weights and weaves, provide reinforcement to the isotropic properties of the molded container. These parameters including the polymers, fabrics, weaves, weights, layers, thicknesses and patterns are designed for individual applications. The molded container 12, being molded of plastic without reinforcing fibers, exhibits physical properties (strength, stiffness) without directionality (isotropic). Woven fabric or cloth, on the other hand, has definite directional properties defined in the industry by terms “warp” and “fill” (anisotropic). Thus the coated fabric layers can be applied to the molded tank in orientations that add strength and stiffness to the final structure.

The at least one self-sealing layer 16 that is applied onto the at least one composite layer 14 includes at least one fuel-activated component that is chosen in accordance with its ability to seal or at least reduce the size of a hole punctured through the fuel container so as to prevent or reduce the loss of fuel. In particular embodiments, the at least on self-sealing layer 16 includes a fuel-activated component that is activated by contact with fuel to quickly swell so as to seal/plug such a hole. In some embodiments, the fuel-activated component is further reinforced by the application of a fabric layer or coated fabric layer (i.e., an additional composite layer) on the fuel-activated component. In some embodiments, multiple layers of the self-sealing layer 16 are applied, and each layer may be the same as or different from other layers. In particular embodiments, the self-sealing layer is a homogeneous rubber compound applied between any two layers of coated fabric if there are more than 2 coated fabric layers.

In one or more embodiments, the fuel-activated component may be selected from natural rubber and compressed polyurethane foam and other viscoelastic materials that swell when in contact with the fuel held in the fuel container 12. In other embodiments the fuel-activated component may be selected from compressed foams such as polyurethane foam (foam rubber), extruded polystyrene (XPS) foam, and polystyrene foam that absorbs, swells or expands in aircraft and vehicle fuel. In a particular embodiment, the preferred self-sealing layer 16 is reinforced with a plain woven nylon cloth or a non-woven sprayed nylon layer or similar materials, such that the self-sealing layer 16 is itself a composite layer. This self-sealing layer is capable of sealing or, at the least, reducing the size of the hole through which fuel may flow out of the tank upon being penetrated by an object such as a bullet or shrapnel from an IED or other explosive. By effectively sealing the puncture itself and limiting the amount of fuel which might otherwise leak through the punctured hole, the self-sealing layer will prevent further damage to other parts of the vehicle, and may prevent ignition of the fuel, and may enable the driver or other operator of the vehicle to continue his mission safely and effectively.

A polymeric outer layer 20 is applied to the completed layup of composite layer 14. The polymeric outer layer 20 may be selected from polyurethane elastomer including formulations of Meggitt (Rockmart), Inc.

In particular embodiments, the outermost layer of the fuel tank 10 is a polymeric outer layer 20. In some embodiments, this polymeric outer layer is selected from urethane to aid in preventing abrasion damage to the tank. In a particular embodiment, the polymeric outer layer 20 is provided by a thin spray coat of a urethane elastomer applied to the outermost composite layer 14. The polymeric outer layer 20 forms a first elastomeric ply. One preferred urethane elastomer is the aforementioned elastomer, chosen so as to contain an amount of solids in solution within the range of 20-70% and preferably about 35-45%. For example, the set time at about 40% is approximately one hour and therefore the set time available between applications of the various plies is sufficient for quality control purposes but is short enough to facilitate a production line type manufacturing process. The elastomer is applied at a preferred rate within the range of 0.38 to 1.89 liters/min dependent upon operator control and, in this instance, to a preferred thickness of up to about 6 mils and preferably to a nominal thickness of about 4 mils or less. Based upon this nominal thickness, the elastomer cover coat 40 should have a weight of about 112 g/m² or less.

The addition of fire retardants, ballistic and other enhancements either uniformly or asymmetrically can be accommodated.

### EXAMPLES

In accordance with the forgoing broader disclosure, a specific embodiment and method of making it is provided below to provide further elucidation of potential nuances of the fuel tanks and methods of forming them.

Smooth any rough places on the outer surfaces of a molded polypropylene container/tank using mild abrasion/sanding. Then, clean the tank with an appropriate non-residual chemical cleaner like methyl ethyl ketone (MEK) to remove any dirt, dust or other debris and/or residual release compounds remaining from the molding. Allow to dry completely before proceeding.

Fill all thru holes with polyurethane fuel resistant adhesive or other similar removable filler. Cover on the inside surface fitting openings, if the tank has any, and any thru holes with a removable masking tape or Teflon, to prevent chemical entry. Allow to adequately dry.

Apply adhesion promoter (primer) compatible to the container, paying special attention to holes and areas where foam is applied to enable adhesion of the cloth and rubber coated cloth parts. Allow to dry before proceeding. After prime dries, apply another coat.

Position any container fittings or special attachments onto the container. Using a marker or other item, outline their edges or the edge of their associated materials. These materials can be flanges or other items that will be in contact with the container's surface. Scuff mildly the flanges and container surface to aid adhesion.

Brush thick polyurethane adhesive onto both sides of the fittings' rubber flange and the area of the box within the mark. Do the same with other attachments. Allow to dry adequately before proceeding.

Assemble the fitting(s) and attachment(s) to the tank. Before attaching, apply to the contact surfaces—flanges and container—polyurethane fuel resistant adhesive. Allow to dry before further handling.

Apply polyurethane adhesive over the entire outside surface. Before it dries, roll or press 65-110 gm/m² polyester cloth into the coating, removing voids and looseness. Allow to dry as needed. Allow the polyurethane coating and cloth to cover the rubber flange or other attachments but not onto the fittings' metal surfaces.

Apply one coat of a polyurethane fuel resistance coating and allow to dry. Cover the flanges and contact-area attachments with the coating.

Apply a coat of adhesion promoter. Allow to dry before proceeding. Cover the flanges and contact-area attachments.

Brush a coat of elastomeric adhesion primer to enhance adhesion.

Apply one ply of 25-100 mils thick rubber calendared on both sides of a 1017±110 g/m² polyester cloth. Use a coat of rubber primer to enhance adhesion of the already applied materials. Place another coat of rubber primer on top of the applied materials.

Apply a layer of 65-110 gm/m² polyester, ensuring that fabric seams don't match or align.

Place a layer 50-200 mils thick self-sealing rubber elastomeric material over container. Also, ensure that rubber seams don't match.

Apply another layer of 65-110 gm/m² lightweight polyester coated with rubber primer (elastomeric primer), ensuring that fabric seams don't match.

Apply one ply of 25-100 mils thick rubber calendared on both sides of a 1017±110 g/m² polyester cloth. Use rubber primer to enhance adhesion of the already applied materials. Place another coat of rubber primer on top the applied materials.

Cover again all fabric-exposed edges with rubber gum strip.

Brush rubber elastomeric adhesion promoter over the entire surface. Allow to dry completely.

Apply one coat each of polyurethane compatible fuel and abrasion resistant coating over the entire surface. Allow adequate drying time between coats.

Follow standard procedure for curing product.

In light of the foregoing, it should be appreciated that the present invention significantly advances the art by providing a fuel tank that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A fuel tank comprising:
a fuel container;
a composite layer covering at least a portion of the exterior of said fuel container, said composite layer including a reinforcing fabric surrounded and supported by a matrix material.

2. The fuel tank of claim 1, wherein said fuel container is a molded fuel container.

3. The fuel tank of claim 2, wherein said molded fuel container is made from materials selected from the group consisting of fuel resistant thermoplastic materials and fuel resistant thermoset materials and nanomaterials formed therefrom.

4. The fuel tank of claim 1, wherein said reinforcing fabric is formed from materials selected from the group consisting sheet-like, woven or non-woven fiberglass, aramid fibers, para-aramid fibers, carbon fibers, polyamide fibers, polyethylene fibers, quartz fibers, ceramic fibers, polybenzoxazole (PBO) fibers, boron fibers, basalt fibers, natural fibers, additive manufactured/3D printed textiles, and nanotextiles versions of the aforementioned.

5. The fuel tank of claim 4, wherein the reinforcing fabric has a weight of greater than 340 g/m².

6. The fuel tank of claim 4, wherein said reinforcing fabric has a thickness of from 30 to 50 thousandths of an inch (mils).

7. The fuel tank of claim 1, wherein said matrix material is selected from the group consisting of formulated rubbers and elastomers having self-sealing properties.

8. The fuel tank of claim 6, wherein said matrix material is urethane elastomer.

9. The fuel tank of claim 6, wherein said matrix material has a thickness of less than 20 mils.

10. The fuel tank of claim 1, further comprising a self sealing layer.

11. The fuel tank of claim 9, wherein said self-sealing layer includes a fuel-activated component that swells when in contact with fuel.

12. The fuel tank of claim 10, wherein said fuel-activated component is selected from the group consisting of natural rubber and compressed polyurethane foam.

13. The fuel tank of claim 10, wherein said self-sealing layer includes a fabric layer for reinforcement.

14. The fuel tank of claim 12, comprising first and second self-sealing layers, wherein said first self-sealing layer includes a first fabric layer reinforcing a fuel-activated component, said first fabric layer being a woven fabric, and said second self-sealing layer includes a second fabric layer reinforcing a fuel-activated component, said second fabric layer being a woven fabric, wherein the woven pattern of said second fabric layer is positioned at an angle to the woven pattern of said first fabric layer.

15. The fuel tank of claim 1, further comprising a polymeric outer layer.
